(19) United States
(12) Patent Application Publication
(10) Pub. No.: US 2016/0128491 A1
(43) Pub. Date: May 12, 2016

(54) A COMBINATION OF CHILD CARRIER AND STROLLER

(71) Applicant: THE UNIVERSITY OF SYDNEY, New South Wales (AU)

(72) Inventors: Alexandra Martiniuk, Sydney, New South Wales (AU); Roman Podrouzek, Sydney, New South Wales (AU); Milles Park, Sydney, New South Wales (AU); Elizabeth Slater, Sydney, New South Wales (AU)

(73) Assignee: The University of Sydney, Sydney, New South Wales (AU)

(21) Appl. No.: 14/904,074

(22) PCT Filed: Jul. 11, 2014
(86) PCT No.: PCT/AU2014/050120

§ 371 Date: Jan. 8, 2016

(30) Foreign Application Priority Data
Jul. 12, 2013 (AU) 2013902586

(51) Int. Cl. A47D 13/02; B62B 7/14; B62B 9/28; A45F 3/14

(52) U.S. Cl. CPC A47D 13/025; A45F 3/14; B62B 7/147; B62B 9/28; A45F 2003/146

(57) ABSTRACT

A combination child carrier and stroller including a stroller (12; 200) having a frame to which is secured wheels; and a child carrier (14; 216) having a saddle-like seating arrangement in which a child is to be seated vertically is provided. The child carrier is configured to be releasably secured to the stroller. Additionally, the child carrier 5 includes a child harness assembly (44; 216) and a carrier harness assembly (50; 226), the child harness assembly including a back support and a child safety harness (64), while the carrier harness assembly includes a carrier frame structure (42) and shoulder straps (46) secured to the frame structure, in order to carry the child carrier on the back of a caregiver. The child harness assembly and the carrier harness assembly are 10 configured to be releasably secured to each other to form a backpack child carrier (14).

### FIELD OF THE INVENTION

This invention relates to a combination child carrier and stroller. The invention extends to a backpack child carrier adapted to be secured to a stroller.

### BACKGROUND OF THE INVENTION

Various child carriers exist to safely carry and/or transport young children such as babies and toddlers.

Some carriers are adapted to be used in a motor vehicle For example, a child safety seat may be secured to a seat or body frame of a vehicle, with the child then buckled into such a seat. These safety seats allow children to be secured in a sitting arrangement where there buttocks and thighs are supported by the chair, while their heads rest on or against an upper portion of the child safety seat. Some infant safety seats are configured to be portable and may therefore have a suitable carrier seat body to be easily securable to and releasable from the vehicle, as well as a handle to carry the carrier seat around.

Other child carriers, for example strollers, provide another safe way of transporting children. Many strollers are adapted to allow for both an upright seating arrangement for a child where the buttocks and thighs are supported by the seat, as well as a collapsed horizontal arrangement where a child can rest in a supine or prone position. Typically, these strollers are further arranged to enable an intermediary sitting arrangement between the upright and horizontal sitting arrangement positions. Strollers are sometimes designed to be modular, which allows different types of baby carriers, (e.g. a baby seat, carrycot etc) to be secured to the stroller frame.

Other child carriers may be in the form of baby slings, backpack carriers, and soft front or hip carriers which secure the child to the caregivers' body. Backpack carriers have historically been very popular with caregivers who enjoy outdoor activities such as hiking. One benefit of backpack carriers, especially for infants old enough to hold their heads up, is that it supports a child in a fully upright body position. Due to the saddle-like seating position, the pelvis is allowed to relax the lower limbs of the child into a neutral or midline position. Notably, this seating position prevents positional plagiocephaly and brachycephaly (referred to herein after as simply plagiocephaly) as the child's head does not rest against a surface, e.g., a headrest, continuously, while seated. In other words, no external force interacts with the back or sides of the child's head (continuously) while in this saddle supported position. This upright seating arrangement is further also the recommended position for infants or children with reflux (i.e. gastro-oesophageal reflux disease). Unfortunately, this fully upright body position is only available when a child is carried on a caregivers' back, or front, in suitable carriers, which does not always make it a convenient way of transporting the child. It is also known that many conventional child carriers, e.g., conventional strollers or the like, may contribute to the likelihood of a child developing plagiocephaly.

It is an object of the present invention to provide an alternative combination child carrier and stroller.

### SUMMARY OF THE INVENTION

According to a first aspect there is provided a combination child carrier and stroller including:
a stroller having a frame to which is secured wheels; and
a child carrier having a saddle-like seating arrangement in which a child is to be seated vertically, the child carrier further including connecting means configured to be releasably secured to the stroller.

The child carrier may include a back support and a child safety harness, the child safety harness providing the saddle-like seating arrangement, and with the back support including the connecting means.

Typically, the child safety harness includes a hip strap and a crotch strap releasably connected to each other, wherein the child straddles the crotch strap while the hip strap stabilises the child's pelvic area while the child is in an upright vertical position. Preferably, the hip strap has two hip strap sections configured to be releasably connected to each other and to the crotch strap, with the hip straps and crotch strap being connected together to form the saddle-like seating arrangement which allows the child's legs to extend generally vertically down from the harness.

The child safety harness may additionally include shoulder straps, which together with the hip strap and crotch strap form a 5-point harness to ensure that the child's head and torso is held in an upright position.

The stroller may include connecting means, to engage with the connecting means of the child carrier, and configured to move the child carrier, once connected to the stroller, from a vertical, upright configuration, to a horizontal, reclined configuration.

The connecting means of the stroller may include a hinge mechanism configured to pivot and lock the child carrier between the vertical upright configuration and the horizontal, reclined configuration. Additionally, the hinge mechanism may be configured to pivot and lock the child carrier in intermediate positions between the vertical, upright configuration and the horizontal, reclined configuration.

The stroller may include a conventional seating arrangement to which is secured the connecting means of the stroller.

The stroller may include two opposing frame sections between which a conventional seating arrangement and/or the child carrier is secured.

The conventional seating arrangement may include a pod seat adjacent to which the child carrier is secured.

The conventional seating arrangement may alternatively include a backrest and seat portion, at least the seat portion configured to be translated from a generally horizontal seating arrangement to a generally vertical collapsed arrangement, the stroller configured to receive the child carrier when the seat portion is in the vertically collapsed arrangement.

The child carrier may include a child harness assembly including the back support and the child safety harness, and a carrier harness assembly including a carrier frame structure and shoulder straps secured to the frame structure. The child harness assembly and the carrier harness assembly may be configured to be releasably secured to each other to form a backpack child carrier. Alternatively, the child harness assembly and the carrier harness assembly may be integrally formed or permanently secured to each other.

The stroller and/or conventional seating arrangement may be configured to allow the conventional seating arrangement to be releasably secured to the stroller in both a front facing and a back facing configuration. For example, respective connecting means may be adapted to allow the conventional seating arrangement and/or the child carrier to be secured to the stroller either with the back of the conventional seating arrangement and/or the child carrier facing towards the front of the stroller (reversed position), or with the front of the conventional seating arrangement and/or child carrier facing towards the front of the stroller.

The child harness assembly and carrier harness assembly may have complementary connecting formations at their respective lower ends and at their respective sides to releasably secure the assemblies together.

According to a further aspect of the invention there is provided a child carrier having a saddle-like seating arrangement in which a child is to be vertically seated in use, the child carrier further including connecting means adapted to be releasably secured to a stroller.

The child carrier may further include:
a child harness assembly including a back support and a child safety harness secured to the back support and providing the saddle-like seating arrangement for a child when secured to the child safety harness; and
a carrier harness assembly including a carrier frame structure and a shoulder straps secured to the harness assembly, the carrier harness assembly to be worn on the back of a caregiver.

The child harness assembly and carrier harness assembly are adapted to be releasably secured to each other to form a backpack child carrier. Alternatively, the child harness assembly and the carrier harness assembly may be integrally formed or permanently secured to each other.

The child carrier may include a back support and a child safety harness, the child safety harness providing the saddle-like seating arrangement and the back support including the connecting means.

Typically, the child safety harness includes a hip strap and a crotch strap releasably connected to each other, wherein the child straddles the crotch strap while the hip strap stabilises the child's pelvic area. Preferably, the hip strap has two hip strap sections configured to be releasably connected to each other and to the crotch strap, with the hip straps and crotch strap being connected together to form the saddle-like seating arrangement which allows the child's legs to extend generally vertically down from the harness.

The child harness may additionally include shoulder straps, which together with the hip strap and crotch strap form a 5-point harness to ensure that the child's head and torso is held in an upright position.

The child harness assembly and carrier harness assembly may have complementary connecting formations at their respective lower ends and at their respective sides to releasably secure the assemblies together.

According to yet a further aspect of the invention there is provided a stroller including:
a frame having two opposing frame sections, each frame section including connecting means to engage connecting means of a child carrier: and
a conventional seating arrangement received and connected between the opposing frame sections, the conventional seating arrangement configured to be at least partially collapsible into a compact configuration in order for a child carrier having a saddle-like seating arrangement in use to be releasably secured to the stroller.

The conventional seating arrangement may alternatively include a backrest and seat portion, at least the seat portion configured to be translated from a generally horizontal seating arrangement to a generally vertical collapsed arrangement, the stroller configured to receive the child carrier when the seat portion is in the vertically collapsed arrangement.

According to a further aspect there is provided a combination child carrier and stroller including a stroller as defined above and a child carrier configured to be secured to the stroller.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 shows a pictorial view of a combination child carrier and stroller in accordance with one example embodiment of the invention;

FIG. 2 shows an exploded view of the main components of the combination child carrier and stroller of FIG. 1, with the child carrier including a child harness assembly and a carrier harness assembly;

FIG. 3a shows an enlarged partial view of the lower end securing means between the child harness assembly and the carrier harness assembly of the child of FIG. 2, also including a partial side cross-sectional view;

FIG. 3b shows side view of the enlarged partial view of the lower end securing means between the child harness assembly and the carrier harness assembly of FIG. 3a;

FIG. 3c shows a top partial cross-section of the securing means between the child harness assembly and the carrier harness assembly of FIGS. 3a and 3b, along line 3c as indicated in FIG. 3b;

FIG. 3d shows a side partial cross-section of the securing means between the child harness assembly and the carrier harness assembly of FIGS. 3b and 3c, along line 3d as indicated in FIG. 3a;

FIG. 4a shows a partial cross-section of the connecting means of the stroller and a side connector of the child harness assembly of FIG. 1;

FIG. 4b shows an enlarged partial side view of the connecting means of the stroller and a side connector of the child harness assembly of FIGS. 1 and 2, the connecting means of the stroller including various parts secured to the frame of the stroller;

FIG. 5 shows the combination child carrier and stroller of FIGS. 1 and 2 wherein the carrier harness assembly has been removed and the child harness assembly is connected to the stroller and lowered into a horizontal position;

FIG. 6 shows a stroller having a conventional seating arrangement configured to be collapsible in accordance with a second embodiment of the invention;

FIG. 7 shows the stroller of FIG. 6 in a vertically collapsed arrangement in order for a child carrier in accordance with an example embodiment to be received by the stroller; and

FIG. 8 shows the stroller of FIGS. 6 and 7 wherein a child is secured in a child harness assembly of the child carrier of FIG. 7, with a carrier harness assembly of the child carrier removed therefrom.

### DETAILED DESCRIPTION OF THE EMBODIMENTS

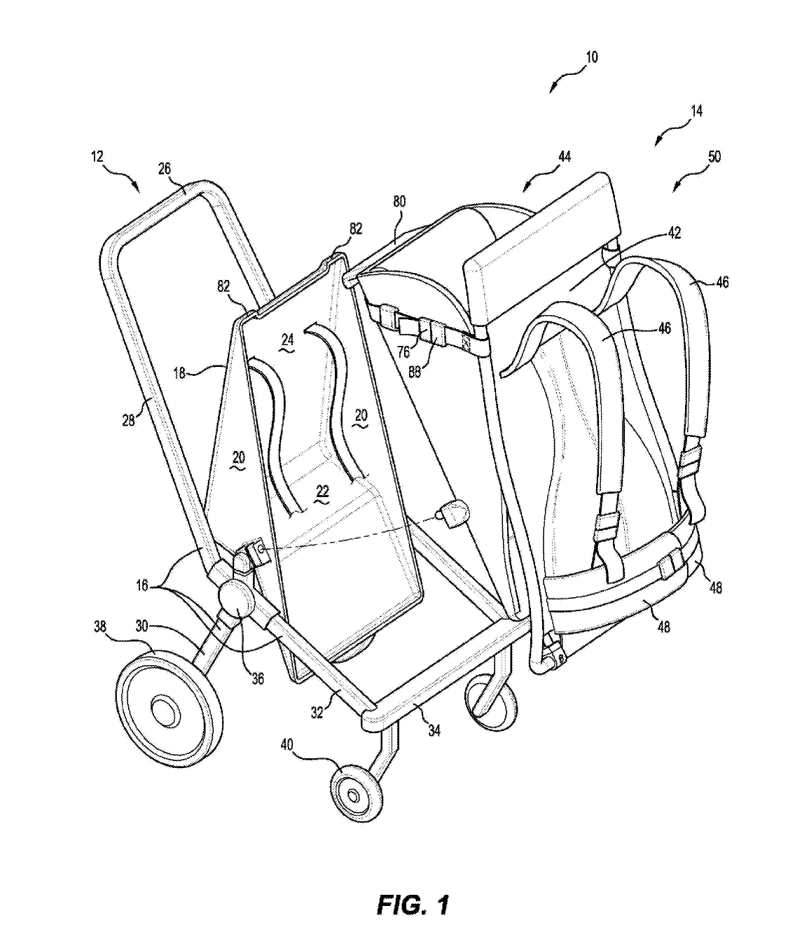

In FIG. 1 a combination child carrier and stroller is generally indicated by reference numeral 10. The combination child carrier and stroller 10 includes a stroller 12 and a backpack child carrier 14 which are in use releasably secured to each other.

Stroller

The stroller 12 has a frame 16 and a conventional seating arrangement 18 which in this embodiment is a seat pod 20 shaped to provide an integral seat portion 22 and backrest 24. The seat portion 22 supports the buttocks and thighs of a child when secured in the seat pod 20.

The frame 16 of the stroller 12 includes a handle 26 and various frame sections 28, 30, 32 and 34. In particular, a pair of opposing side frame sections 28 terminate on one end in the handle 26, and are connected on another end to connecting means 36. The features of the connecting means 36 will be described in more detail later in the document, The handle 26 may be integrally formed with the frame sections 28 and is used to steer and push the stroller 12.

In the example embodiment as shown in FIG. 1, two different pairs of frame sections 30, 32 extend downward from the connecting means 36 on each side of the stroller 12. The ends of these pairs of frame sections 32, 34 are secured to the wheels (or wheel sections) of the stroller 12. In particular, back-wheel frame sections 30 (only one of which is visible in FIG. 1) extend downward and toward the back of the stroller 12. Secured to each of these frame sections' terminating ends is a back wheel 38. Similarly, side frame sections 32 extend from the connecting means 36 towards the front of the stroller 12, providing opposing sides of a lower outer frame for the stroller 12, which at least partially surrounds the conventional seating arrangement 18 of the stroller 12. Wheel sections to which the front wheels 40 are secured extend from the terminating ends of the side frame sections 32. In this embodiment and in order to provide the frame 16 of the stroller 12 with proper structural integrity, a lower frame section 34, cross bar or footrest is secured between the ends of the side frame sections 32. It will however be appreciated that the lower frame section 34 may in alternative embodiments be integral with the opposing side frame sections 32, thereby forming a U-shaped section that frames the lower end of the conventional seating arrangement 18 and from which wheel section may extend.

The seating arrangement 18 is carried between the frame 16 of the stroller 12, with the seating arrangement 18 in this example embodiment being secured to the frame 16 via the connecting means 36. In particular, the handle 26 and frame sections 28, 32 and 34, together with the connecting means 36, provide an outer frame assembly between which the conventional seating arrangement 18 is held and secured, Advantageously, the outer frame assembly protects the child against impacts of the stroller with objects, especially when the conventional seating arrangement 18 is used, and potentially when the backpack child carrier 14 is secured to the stroller.

As mentioned above, the conventional seating arrangement 18 is secured to the connecting means 36 that forms part of this outer frame assembly. The connecting means 36 may also allow relative adjustment of the various frame sections 28, 30 and 32 with each other, thereby to either adjust the height of the handle 26 or the height of the seating arrangement 18 or child carrier 14 within the stroller 12.

In some embodiments, the connecting means 36 may be configured to allow the conventional seating arrangement 18 to be detachable from the stroller 12. For example, the conventional seating arrangement 18 may be releasably detachable from the stroller 12 in order to reverse the seating arrangement 18 to face towards the handle 26 of the stroller 12. The seating arrangement 18 is thus reversible within the outer frame of the stroller 12, allowing the seating arrangement (and in some embodiments also the connected child carrier 14) to be secured with the stroller frame either back to front, or front to back. For example, respective connecting means may be adapted to allow the conventional seating arrangement 18 and/or the child carrier 14 to be secured to the stroller 12 either with the back of the conventional seating arrangement and/or the child carrier facing towards the front of the stroller (reversed position and not shown), or with the front of the conventional seating arrangement 18 and/or child carrier 14 facing towards the front of the stroller 12 (as shown in FIGS. 1, 2 and 5). In an alternative arrangement, the conventional seating arrangement 18 may be adapted to be released from the stroller frame 16 in order to secure the seating arrangement 18 as a child safety seat in a vehicle, or in some embodiments, in order to secure the child carder 14 to the stroller.

The conventional seating arrangement 18 and/or the stroller 12 may be adapted to move the seating arrangement 18 between an upright seating position and a collapsed reclined position. In the upright seating position, and as mentioned above, the child is to sit substantially upright, with the child's buttocks and thighs supported by the integral seat portion 22 of the seat pod 20. In the reclined position, the child can rest in a supine or prone position.

A person skilled in the art will appreciate that the frame 16 of the stroller 12 may be further adapted to provide the stroller 12 with specific features. For example, the stroller frame 16 and connecting means 36 of the various frame sections may be configured to allow for easy collapsibility (and hence storage) of the stroller 12. Alternatively or in addition, the stroller frame 16 and the wheels 38, 40 may be adapted to provide the stroller with improved mobility. For example, the stroller frame may be adapted to allow for a three-wheel configuration, i.e. a configuration where the stroller has two back wheels and one central front wheel. A person skilled in the art will appreciate that the frame structure of conventional strollers with a three-wheel arrangement will need to be adapted in order to provide sufficient space and support for the backpack child carrier (or parts thereof) as described herein to be received in such stroller.

Child Carrier

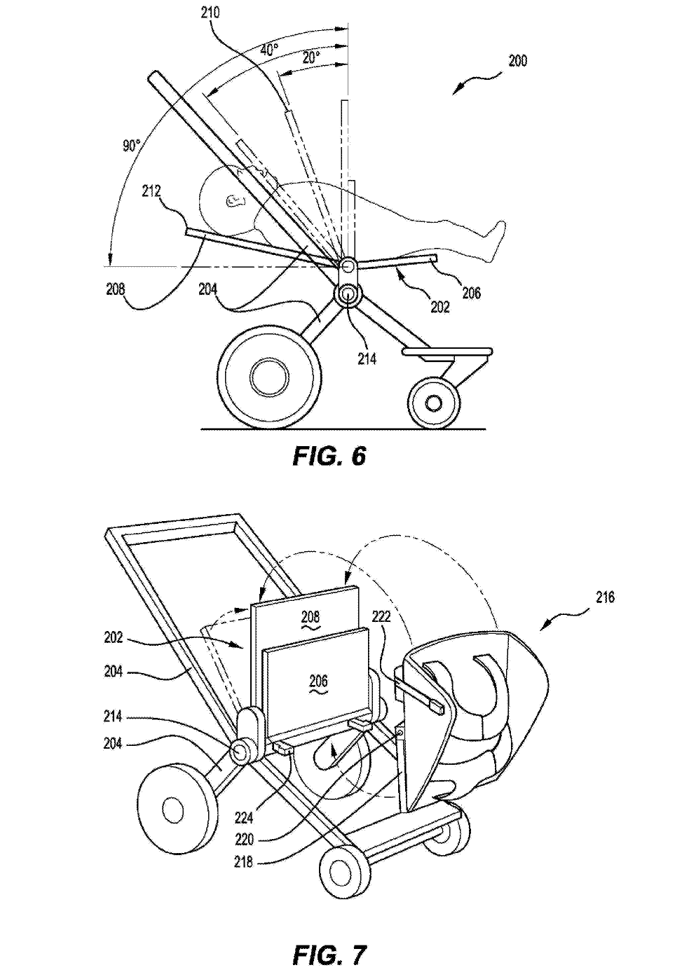

As described in more detail below, the backpack child carrier or at least a portion thereof, may be releasably secured to the stroller. For example, the child carrier 14 may either be releasably secured and connected to the frame 16 of the stroller 12, e.g., directly to a frame section or to the connecting means 36 of the stroller 12 (see FIGS. 1 to 5). Alternatively, in a different example embodiment, the child carrier 216 may be releasably secured directly to a conventional seating arrangement 202 of the stroller 200 (see FIGS. 6 to 8). It will however be appreciated that the connecting means and connecting arrangements may in some embodiments also be configured to allow for connections to one of more of the frame, connecting means or conventional seating arrangement.

When not connected to the stroller, the backpack child carrier is used to carry a child on the back of a caregiver. Notably, the child carrier provides a child safety harness, described in more detail below, that ensures that the child is seated in a saddle-like arrangement. Thus, the harness provides for hip-straps and a crotch strap that are connected together to form a nappy-like harness seat allowing the child's lower body to be securely held in the harness without supporting the child's thighs, the child's pelvis being allowed to relax the lower limbs of the child into a neutral or midline position. The child's head and torso are held in an upright position, limiting plagiocephaly and other problems associated with conventional seating arrangements, such as reflux

The child carrier 14 as shown in FIG. 1 typically has a carrier frame structure 42 that provides support and structural strength to the carrier 14. Secured to the frame structure 42 is a child compartment or child harness assembly 44 which provides the abovementioned saddle-like seating arrangement in which a child is to be seated in a vertical position. On an cuter side of the child carrier 14, and secured to the frame structure 42, are shoulder straps 46, typically adjustable, which are placed over the shoulders of a user, e.g., a caregiver, thereby allowing the caregiver to carry a child in the backpack child carrier 14 on the caregiver's back. A hip belt 48, which has two portions, preferably configured to be adjustable and padded, is secured to the lower end of the frame structure 42. In use, opposing loose ends of this hip belt 48 is fastened with adjustable connectors, typically a male/female buckle or snap-fit connector, around the waist or hips of the caregiver. The belt 48 is tightened to assist in the distribution of the weight of the child carrier 14 and the child onto the caregiver's body.

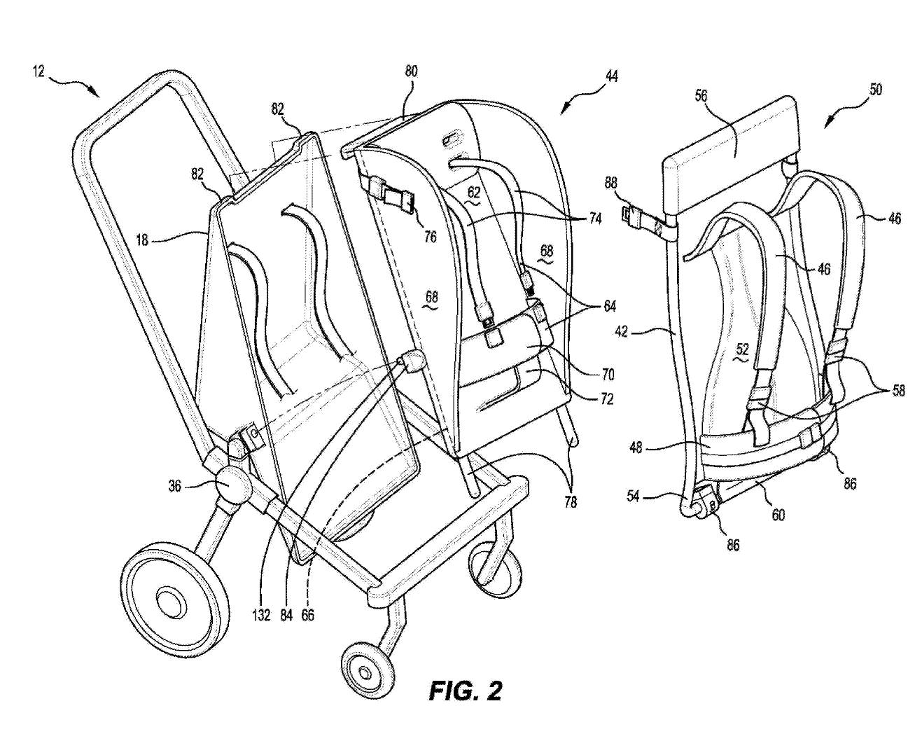

Turning now also to FIG. 2, the child carrier 14 is shown to include both the child compartment or harness assembly 44 and a carrier harness assembly 50. It will be appreciated that although the child harness assembly 44 and carrier harness assembly 50 are shown to be distinct parts of the backpack child carrier 14 which are releasably secured to each other in this embodiment, these parts may be integrally formed with or fixedly secured to each other in other example embodiments of the invention. The use of the term “child carrier” in this disclosure may therefore refer to the two assemblies connected together, a single unit backpack child carrier or alternatively, to a part of the backpack child carrier, in particular the child harness assembly 44.

Carrier Harness Assembly

As is best shown in FIG. 2, the carrier harness assembly 50 includes the abovernentioned frame structure 42 to which is secured the adjustable shoulder straps 46 and the adjustable padded hip belt 48. In this example embodiment, the frame structure 42 of the carrier harness assembly 50 is in the form of an elongate backrest 52 which terminates at its lower end in a generally U-shaped frame 54 and has at its upper end a cross bar 56. The U-shaped frame 54 may be secured to the backrest 52 or may be integrally formed with it. In either case, it may, but need not, extend to the cross bar 56. In this example embodiment, the shoulder straps 46 and padded hip belt 48 are formed and secured to the frame structure 42 to allow vertical adjustment thereof. For example, either the shoulder straps 46, or the hip belt 48 or both may be vertically adjusted along the length of the backrest 52. The shoulder straps may individually be adjustable, through an adjustable connector, e.g., snap-fit connecters 58, thereby in order to tighten the backrest 52 and accordingly the carrier harness assembly 50 onto the back of a caregiver.

The backrest 52 may be shaped to comfortably fit onto the back of a user. It is envisioned that the backrest 52 will be of similar construction as structures used for existing backpacks, e.g., having an internal frame with padded material. Similar to existing backpacks, the shoulder strap and hip belt configuration is secured to the backrest 52 (and the carrier frame structure 42) to ensure that the frame structure 42 is maintained in an upright position when a user wears the carrier harness assembly 50 as part of the backpack child carrier 14 on the caregiver's back.

As shown in FIGS. 1 and 2, in this example embodiment a padded material forms a closed sleeve or pocket 60 that surrounds and covers the internal frame. The closed sleeve or pocket 60 may have open corners into which the internal frame, in particular the U-shaped frame 54, of the carrier harness assembly 50 is received. The corners of the U-shaped frame 54 extend through the open corners of the pocket 60.

In a different example embodiment, the carrier harness assembly 50 may not include a backrest 52 formed with an internal frame and padded material, but may have an adapted frame structure configured into an external frame assembly to which is secured a suitable shoulder straps and hip belt configuration.

In general, the padded material used in the backpack carrier would be selected to be provide sufficient structural support, if necessary, while being lightweight and breathable.

The carrier harness assembly 50 is also configured to be secured to the child harness assembly 44. As shown in FIGS. 1 and 2, the two harness assemblies 44 and 50 have corresponding securing means at their lower ends and at their sides, which will be described in more detail further below.

Child Harness Assembly

Turning now to the child harness assembly 44, the child harness assembly 44 has a back support 62, to which is secured a saddle-like seating arrangement. The saddle-like seating arrangement may be integrally formed with, or alternatively secured to, the backsupport 62 and will typically be adjustable. In this example embodiment, the saddle-like seating arrangement is in the form of a 5-point child safety harness 64.

In some example embodiments, the back support 62 may be manufactured from a rigid or semi-rigid plastic moulding, typically a suitable synthetic polymers or plastics material, which is padded to provide comfort to a child, whether the child harness assembly 44 is in a vertical or horizontal position. The padding may be secured to the moulding in a suitable way. Integral with the back support 62 would be a frame structure 66 that is used, in the present embodiment, to secure the child harness assembly 44 both to the stroller 12 and to the carrier harness assembly 50.

Extending from two opposing sides of the back support 62 are side panels 68, which are shaped and configured to provide, together with the back support 62 and the frame structure 42 of the carrier harness assembly 50, a safe child compartment when the child harness assembly 44 is connected to the carrier harness assembly 50. In some example embodiments, the side panels 68 may be removable from the child harness assembly 50, e.g., once the assembly 50 has been secured to the stroller 12.

The child safety harness 64 includes five straps, i.e. two hip straps 70, one crotch or seat strap 72, and two shoulder straps 74. All or some of the straps may be padded. The configuration of the padded crotch strap 72 and hip straps 74, similar to a nappy configuration, allows a child to sit in an upright saddle-like position once secured to the harness 64. The crotch strap 72 is specifically shaped and configured to pass from the buttocks of a child in the safety harness, between the child's legs, the child in effect straddling the crotch strap 72, with the end of the crotch strap 72 then secured to the hip straps 70 in the child's tummy region. The crotch strap 72 is narrow enough to ensure that it provides no (or very limited horizontal) support for the thighs of the child, allowing the child's legs to extend generally vertically downwards from the harness 64. Thus, the saddle-like seating position allows the child's pelvis to relax the lower limbs of the child into a neutral or midline position.

The crotch strap 72 is typically manufactured from a semi-rigid material which carries the child's weight by allowing the child to straddle it. For comfort, at least the hip straps 70 and crotch strap 72, which provide the saddle-like seating arrangement, are padded. In one example embodiment the crotch strap 72 may also be made of two adjoining materials to create two adjoining regions, i.e. a central, more rigid support structure that provides a ‘nappy configuration’ as well as extensions from this central structure formed of less rigid and softer material as a safeguard against inadvertent pressure on a child's inner thighs.

Once secured in position, the shoulder straps 74 ensure that the body of the child does not lean or fall forward within the child compartment. The shoulder straps 74 are of further of importance to ensure that the child cannot fall out of the backpack child carrier 14 should the carrier 14 fall over, or should the wearer of the backpack carrier 14 fall down.

The five straps are all releasably securable and adjustable, thereby to ensure that the child is maintained in a comfortable secure position in the child harness assembly 44. This also allows adjustment of the child safety harness 64 of the carrier 14 to accommodate a growing child (or use of the carrier with different children).

In the example embodiment shown in FIGS. 1 and 2, the hip straps 70 are secured to each other and to the crotch strap 72 with hook-and-loop fasteners, while the shoulder straps 74 make use of snap-fit fasteners. However, a person skilled in the art will appreciate that many other connection mechanisms may be used for the 5-point harness, for example a 5-point buckle or other suitable buckles or combination buckles, as well as one or more other male-female fasteners or connectors.

As already mentioned, the child harness assembly 44 is configured to be connected and secured to the carrier harness assembly 50 thereby to form the backpack child carrier 14. The backpack carrier 14, and in this example embodiment, particularly the child harness assembly 44, is further configured to be connected and secured to the stroller 12 thereby to allow the child, while still secured in the child harness assembly 44, to be pushed in the stroller 12 in an upright position, or to be laid down in order to rest or sleep.

The securing means to secure the child harness assembly 44 to the carrier harness assembly 50 includes side strap connectors 76 secured to the side panels 68 of the back support 62. Also, towards the lower end of the back support 62 of the child harness assembly 44, the frame structure 66 terminates in frame ends 78, in this embodiment with rounded ends, which also form part of the securing means to secure the child harness assembly 44 to the carrier harness assembly 50.

In terms of means to connect the child harness assembly 44 to the stroller 12, an upper securing means in the form of a bracket 80 forms part of the back support 62. The bracket is received between outer side stops 82, in this example embodiment shown as protrusions, located on an upper edge of the pod seat 20 between which the bracket 80 is held. In alternative embodiment, the outer side stops may be clamps positioned onver the upper outer edges of the pod seat 20. These features accordingly provide a first connection step between the child harness assembly 44 and the stroller 12. It will be appreciated that the upper securing means may have a different but suitable structure.

Further connecting means 84 is located on respective opposing sides of the back support 62, thereby further to secure the child harness assembly 44 to the stroller 12 once the bracket 80 has been hooked over the upper end of the seating arrangement 18. These connections are described in more detail below.

Securing Means Between Child Harness Assembly and Carrier Harness Assembly

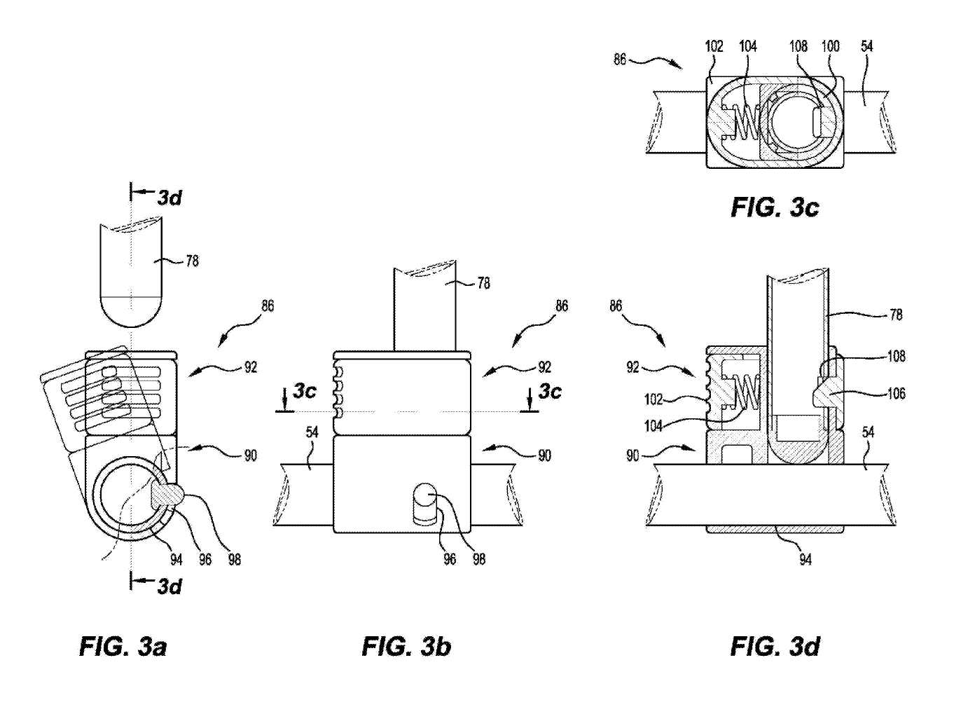

The securing means to secure the child harness assembly 44 and the carrier harness assembly 50 together thereby to form the backpack child carrier 14 are now described in more detail with reference also to FIGS. 3a to 3d.

As mentioned, the relevant securing means of the child harness assembly 44 includes base connectors in the form of the frame ends 78 of the frame structure 66 of the back support 62 (best seen in FIGS. 3a and 3d) as well as the side strap connectors 76 which extend from the frame structure 66 of the back support 60 (best seen in FIGS. 1 and 2). The corresponding securing means of the carrier harness assembly 50 is in the form of complementary base connectors 86 located on the U-shaped frame 54 (best seen in FIGS. 3a to 3d) and complementary strap connectors 88 (best seen in FIGS. 1 and 2).

The side strap connectors 76 and 88 are typically snap-fit connectors in the form of respective male and female parts that are easily connected and/or disconnected. The straps themselves may additionally be adjustable thereby to configure the backpack child carrier 14 in accordance with the age and size of the child to be carried therein.

Each of the base connectors 86 of the carrier harness assembly 50 includes a swivel connector part 90 and a catch mechanism 92 that is typically spring-biased. The swivel connector part 90 defines a passage 94 with an elongate side slot 96. A portion of the U-shaped frame 54 is received in the passage 94 which allows a level of rotation of the frame 54 within the swivel connector part 90, and accordingly a level of pivot of the child harness assembly 44 relative to the carrier harness assembly 50. In order to limit the degree of swivel, the U-shaped frame 54 has a externally extending lug or pin 98 that may be biased in order to collapse into the frame 54 until the pin 98 is aligned with the side slot 96 of the swivel connector part 90. Once aligned, the biased pin 98 is released to extend through the side slot 96, thereby limiting the swivel or pivot of the base connector part 86 around the frame 54 to the length of the side slot 96. The allowable pivot of the base connector 86 is best seen in FIG. 3a.

Each spring-biased catch mechanism 92 of the base connectors 86 defines an aperture 100 to receive one frame end 78. The catch mechanism 92 further includes a release button 102 biased by an internal spring 104. On the opposing side of the spring 104, the release button 102 includes an internal extending catch 106 that snap-fits into an aperture 108 defined in the lower part of the frame ends 78 to securely connect the lower ends of the two harnesses together. When the release button 102 is pressed, the catch 106 is released to allow the two harness assemblies 44 and 50 to be disconnected.

In securing the child harness assembly 44 and the carrier harness assembly 50 together, a user will first secure the child in the child harness assembly 44 by fastening the various straps of the 5-point child safety harness 64. The frame ends 78 of the assembly 44 are then to be located and secured in the spring-biased catch mechanisms 92 of the base connectors 86. Once locked in the swivel arrangement, the strap connectors 76 and 88 are secured and tightened to provide a safe and secure child compartment within which the child is held while being carried in the backpack child carrier 14.

Connecting Means Between Child Harness Assembly and Stroller

As mentioned, the combination child carrier and stroller 10 also allows for the child, while held in the child carrier, to be secured in an upright position in the stroller 12. In the event that the backpack child carrier is an integrated unit, the integrated carrier 14 is secured to the stroller 12. Alternatively, as in the present embodiment, only a portion of the backpack child carrier 14, in particular the child harness assembly 44, is secured to the stroller 12. The child harness assembly then lies flush with the outer rim of the pod seat 20. Notably, in some embodiments where the child carrier (or particularly the child harness assembly) is directly or indirectly connected to the conventional seating arrangement, such as the pod seat 20, the conventional seating arrangement (with the child carrier) will typically be pivotable in the stroller to a vertical upright arrangement thereby to allow the child carrier to hold the child in an upright (and not a reclined) position. In other words, the conventional seating arrangement may in some example embodiments be moved, prior or after connecting the child carrier thereto, to a position different from the sitting configuration for the conventional seating arrangement, thereby to allow the child carrier to have a generally vertical arrangement. In order to ensure that the child carrier is stable in this position. a suitable lock or securing arrangement may be provided to the connecting means that enables the pivot.

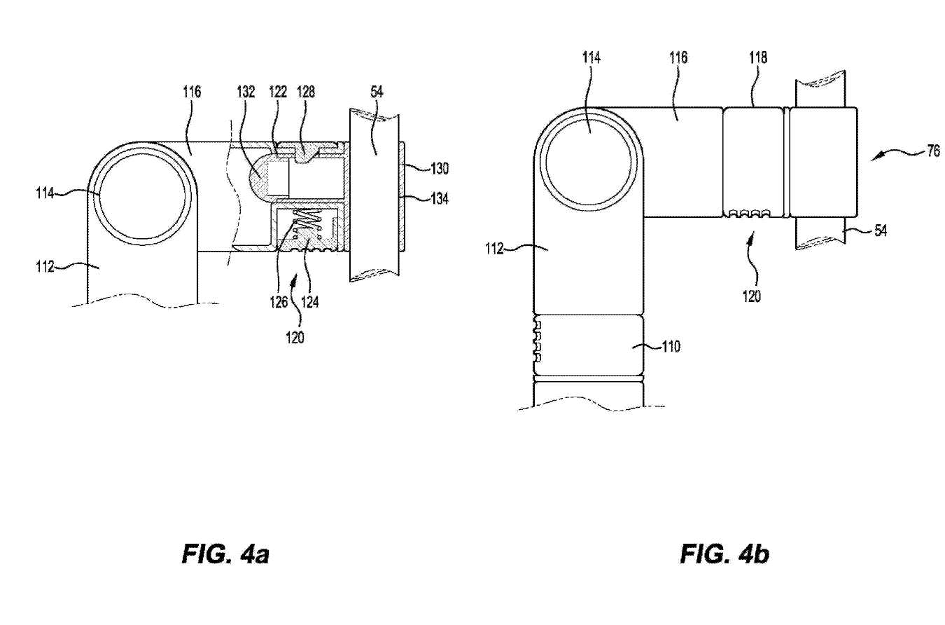

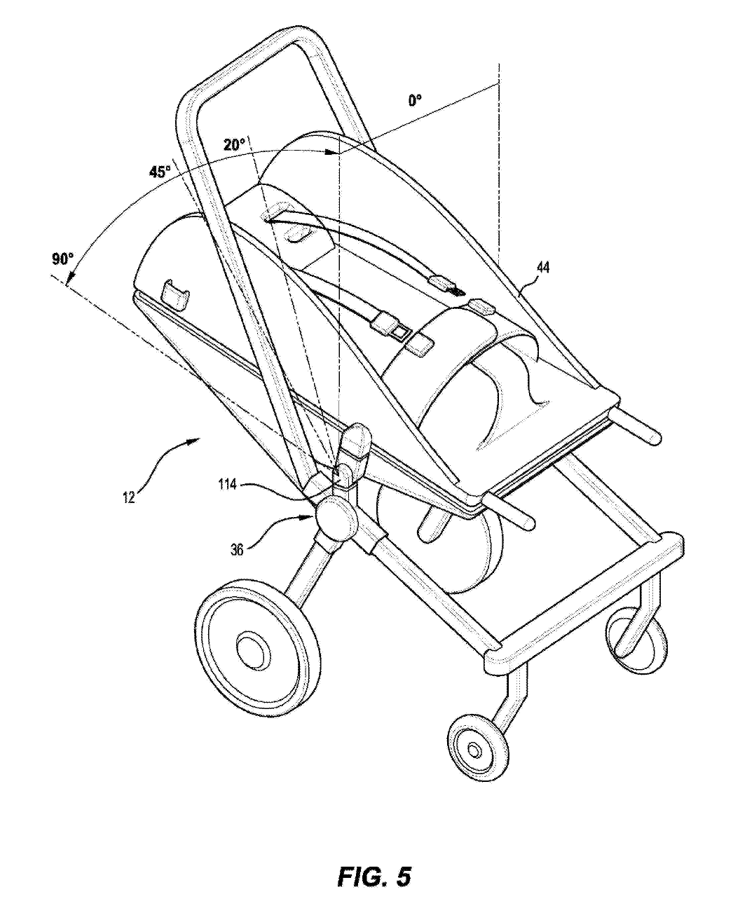

As can be seen from FIG. 2, the carrier harness assembly 50 may be disconnected from the child harness assembly 44 by disconnecting the side strap connectors 76 and 88, and then releasing the frame ends 78 from the base connectors 86. The bracket 80 is fitted over the end of the conventional seating arrangement 18 between the outer side stops 82 of the pod seat 20 which limits the lateral movement of the child harness assembly 44 between the side stops 82. To support the full weight of the carrier 14 (or child harness assembly 44) and child during a process of connecting the child harness assembly 44 to the stroller 12, the bracket 80 is integrally formed with the frame structure 66 of the back support 62 of the child harness assembly 44. The bracket 80 snugly fits over an upper end of the conventional seating arrangement 18. The next step is to secure the connecting means 84 on the sides of the child harness assembly 44 to the corresponding connecting means 36 on the sides of the stroller 12. This connection arrangement is now described with reference to FIGS. 4a and 4b.

In this example embodiment. the connecting means 36 on each side of the stroller 12 includes a release button connector 110 connected to a fixed arm 112, in turn connected via a hinge mechanism 114 to a pivot arm 116. The pivot arm 116 has at its free end a connector 118 which includes a spring-biased catch mechanism 120 similar to the catch mechanism 92 described above. The catch mechanism 120 defines an aperture 122 to receive an end projection 132 of the child harness assembly's connecting means 84. The catch mechanism 120 further includes a release button 124 biased by an internal spring 126. On the opposing side of the spring 126, the release button 124 includes an internally extending catch 128 that is released when the release button 124 is pressed.

In turn, each of the connecting means 84 includes a partial sleeve or connector 130 which is secured to respective sides of the back support 62, typically to the frame structure 66. Extending from the connector 130 is the end projection 132 (mentioned above), in this example embodiment with a circular cross-section, On one side thereof, the end projection defines a slot 134 to engage with the catch 128 of the catch mechanism 120. In connecting the child harness assembly 44 and the stroller 12 together, the respective connecting means 84 is aligned with the connectors 118, Once aligned, the respective projections 132 are received in the apertures 122 of each of the catch mechanisms 120, with the respective catches 128 fitting securely in the slots 134, thereby securing the male and female parts of the connecting means together.

The release button connector 110 on each side of the carrier 12 is in turn used to reverse the conventional seating arrangement (and in some embodiments also the connected child carrier) to face the other way, while the hinge mechanism 114 allows relative movement between the various frame sections 28, 30 and 32 of the stroller 12.

It will be appreciated that the carrier harness assembly 50 need not be disconnected from the child harness assembly 44 prior to connecting the carrier harness assembly to the stroller 12.

Combination Child Carrier and Stroller

Turning now to FIG. 5, the child harness assembly 44 is shown as secured to the stroller 12 through the bracket 80 (not visible) and the respective connecting means of the two parts. The child harness assembly 44 is shown as tilted or pivoted by 90°, thereby providing an arrangement where the child may rest or sleep in a horizontal position while secured to the child harness assembly 44. With the child safety harness 56 being offset from the edge of the back support 62, at least a part of the thighs, and in the case of infants, the lower legs, of the child will be supported by the back support 62 in this configuration.

As mentioned, the hinge mechanism 114 allows for the movement of the child harness assembly 44, together with the seat pod 20 from the vertical to the horizontal position. The hinge mechanism 114 may further allow for movement to and between intermediate locking positions, e.g., a 20° from vertical position and 45° from vertical position. In a preferred arrangement, the child harness assembly 44 may be used in the vertical (0°) position, i.e. allowing the child to be in an upright position in the saddle-like seat, while being transported in the stroller 12.

Advantageously, this embodiment of a combination child carrier and stroller 10 thus provides both a normal seating position for a child (when the child is seated in the pod seat 20), as well as an upright saddle-like seating arrangement (when the child carrier 14 is connected to the stroller and in an upright position). Additionally, the child could easily be moved to a horizontal sleeping position by merely reclining the child carrier 14 as connected to the conventional seating arrangement 18.

### Further Embodiments

With reference now to FIG. 6, a stroller 200 is shown to have a different conventional seating arrangement 202 to the seating arrangement 18 of the stroller 12 of FIGS. 1 to 5. The stroller 200 does have a frame 204 similar to the frame 16 of stroller 12 described above. In this embodiment, and for example to allow for a carrier harness assembly forming part of a child carrier to have a lower centre of gravity that results in a more stable stroller combination and additionally also to accommodate an older child with longer legs, the stroller may be adapted to allow for the conventional seating arrangement to be partially folded away.

This conventional seating arrangement 202 of the stroller 200 includes a seat portion 206 and a reclining backrest 208, hingedly connected together. As shown in FIG. 6, the backrest 208 may be reclined from an upright sitting position, which is typically offset from the vertical, e,g., by 20° as indicated by reference numeral 210 in FIG. 6, to a reclined position which is typically slightly offset from the horizontal, e.g. between 5 to 10° as indicated by reference numeral 212. The backrest 208 may additionally be reclined or raised into various intermediate positions. A hinge or pivot mechanism 214, to which the seat portion 206 and reclining backrest 208 are connected, allows for this type of adjustment. The pivot mechanism 214 may further be configured to lock the backrest 208 in place in the different positions. Various pivot mechanisms that would be suitable for use in the stroller 200 could be used.

In one example embodiment, the conventional seating arrangement 202, and in particular, the pivot mechanism 214, may be adapted to allow for a child carrier 216, similar to the child carrier 14 described above, to be secured to the seating arrangement 202 and/or stroller frame 204. As the child carriers 14 and 216 are to have similar features, this part of the description is only focused on features that vary between the carriers 14 and 216.

Insofar as these adaptations concern the stroller, and as best shown in FIG. 7, the seating arrangement 202 and pivot mechanism 214 are adapted to allow the backrest 208 to be moved from the seating position 210 to a vertical position, while the seat portion 206 is pivoted from a horizontal position also to a vertical position. The combination vertical seat portion 206 and backrest 208, i.e. a collapsed seat arrangement, provides a support to which the child carrier 216 may be releasably secured. It will be appreciated that in other embodiments the conventional seating arrangement 202 may include different collapsing means to move a portion of the seating arrangement to such a collapsed position (and to provide such a connection support).

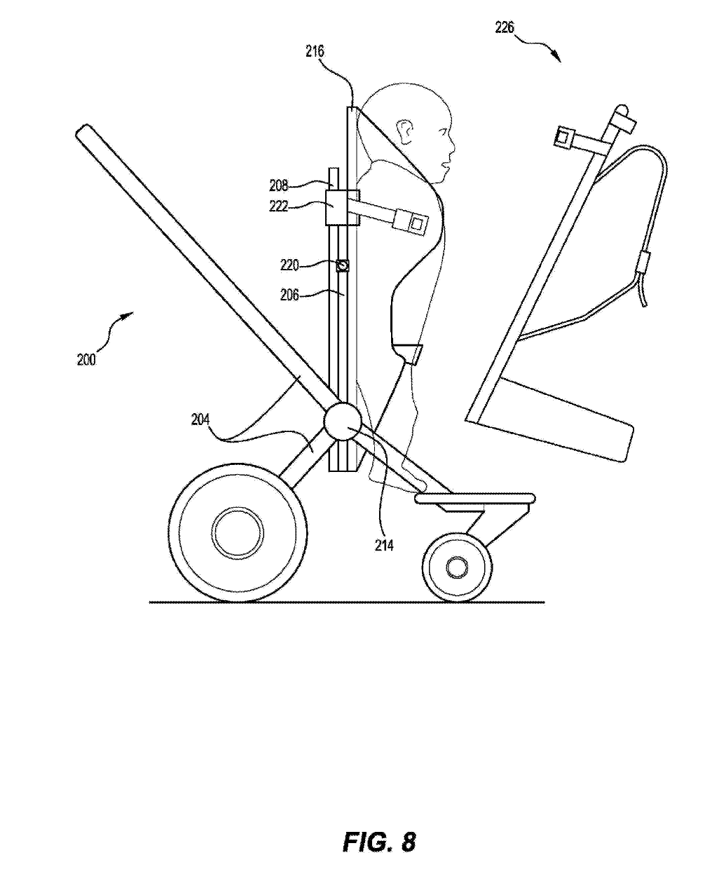

Note that in this embodiment the child carrier 216 is similar to that described above. In FIG. 7 only the child harness assembly is shown, while FIG. 8 shows both the child harness assembly and the carrier harness assembly. As already mentioned, the child carrier could also be an integrally formed backpack child carrier.

To connect the child carrier 216 to the seating arrangement, the child carrier 216 of FIG. 7 includes on either side thereof guide rails 218 that are secured to a hinged stop 220 at the back of the child carrier 216. The guide rails 218 are configured to engage the side edges of the seat portion 216, while the hinged stop 220 will abut a front edge of the seat portion 206. Clip-over brackets 222, shaped and configured to clip over the upper side edges of the collapsed seating arrangement as shown in FIG. 7, are provided on the outer upper sides of the back support of the child harness assembly 216. Towards the lower ends of the back support of the child harness assembly, a securing mechanism (not shown) is provided which engages with biased clips 224 located on the bottom of the seat portion 206.

In connecting the child carrier 216 to the collapsed seating arrangement 202 of the stroller 200, the guide rails 218 are slid over the sides of the seat portion 206 while the seat portion 206 is in an upright position. The hinged stop 220 limits the translation of the guide rails 218 over the sides of the seat portion, at which point the clip-over brackets 222 are forced over the upper ends of the backrest 208 (collapsed seating arrangement), while the biased clips 224 engage the securing mechanism of the carrier 216. In effect, the child carrier 216 is piggy-backed onto the seating arrangement 202 which allows the child carrier 216 to be positioned either in an upright position (best shown in FIG. 8) or in a horizontal position. A child is also shown in the saddle-like seating arrangement in FIG. 8, where the child safety harness provides the saddle-like seating arrangement, the child straddling the crotch strap while the hip strap stabilises the child's pelvic area while the child is in an upright vertical position. The carrier harness assembly 226 is shown as removed from the child carrier in this configuration.

It will be appreciated that different connecting means may be used between the child carrier 216 and the seating arrangement 202 of the stroller 200. A person skilled in the art would appreciate that other embodiments could provide magnets, sleeves and/or other suitable male/female connectors could be employed to secure the child carrier 216 in place.

It would further be appreciated that the system could be adapted to allow for the rotation of the seating arrangement and, with that, the child carrier, thereby to enable the child to face towards or away from the person pushing the stroller whilst still being held in the child carrier 216.

It is also expected that the conventional seating arrangement described above in relation to FIGS. 1 to 5 and 6 to 8 of some strollers may be entirely removed prior to securing the child carrier 14 or 216 to the stroller. In such embodiments, the connecting means of the stroller will be adapted to be secured to the child harness assembly (or child carrier) and to provide various lockable positions of the assembly between and upright position and a horizontal position.

A person skilled in the art will further appreciate that, although two embodiments of connecting means between the stroller and the parts of a backpack child carrier have been described above, various other variations of releasable connecting or securing means may be suitable Typically, the connecting or securing means may take the form of corresponding male and female connectors on opposing ends of respective parts, another example of which is described in Australian provisional application no. 2013902586 by the same applicant, which is hereby incorporated by reference in its entirety. In this example embodiment, a frame of the stroller is adapted to receive connecting means of a backpack carrier, in particular by defining in each of two opposing frame members of a stroller a connector, shown as a female connector, to receive the corresponding male connectors of the carrier.

Alternatively, the stroller may have male connectors while the carrier defines female connectors. In yet other alternatives, suitable clip arrangements or other interlocking arrangements may be used.

In the above embodiments, the various frame components may be manufactured from aluminium and/or other lightweight metal alloys. Some or all components, especially the panels, may also be manufactured from suitable synthetic polymers or plastics.

In considering and designing the various embodiments of the combination child carrier and stroller, such as those shown in FIGS. 1 to 5, and FIGS. 6 to 8, the centre of gravity of the combination should be considered. It has, for example, been found that the child carriers should ideally be connected to the stroller with connectors located approximately 15 cm above the child's crotch, when secured in the child safety harness. Embodiments of the invention may for this reason include a double-pivot connecting mechanism, e.g. for connecting means 36 and 214, thereby allowing the effective lowering of the child carrier in the stroller,

Alternative/Additional Features

The example embodiments described herein may be adapted to include various additional features. For example, in one example embodiment the 5-point child safety harness of the child harness assemblies 44 and 216 may be configured to allow for the hip straps 70 and the crotch or seat strap 72 to be vertically (height) adjustable, thereby allowing the child harness assembly's ‘seat’ to be raised and lowered. This type of configuration provides the capability of accommodating children at different ages (i.e. children of different sizes and height). In one example embodiment, the back support of the child carrier may provide multiple moulding slots through which straps of the harness may be pulled. Other suitable arrangements to allow for this adjustment could also be used, for example a configuration where one of more parts of the 5-point child safety harness is connected to a frame, along which the parts may slide and be locked, ire a vertical arrangement.

In general, the safety harness, and in particular the crotch strap, is situated so that the child's entire body is within the compartment provided between the backrest 62 (frame structure 66) of the child harness assembly 44 and the back support 52 (or frame structure 42) of the carrier harness assembly 50. The connection point of the crotch strap to the hip straps may therefore be situated generally midway between the top and bottom of the backrest 62, or slightly below this midway point in order to take the centre of gravity into consideration. In general, the child will have enough space to sit comfortably between the backrest 62 and frame structure 42. If necessary, the frame structure 66 of the child harness assembly 44 may be configured to incorporate sufficient curvature to accommodate the child's body. Other adaptations may also be made, e.g., extending the frame ends 78, including a sufficient curvature in the frame ends, or the like. It will also be appreciated that in some embodiments, even though the child's torso and pelvic area would be contained in the compartment between the backrest 62 of the child harness assembly 44 and the back, support 52 of the carrier harness assembly 50, the child's legs may dangling downwards and outside of the compartment. This may especially be the case when the child is older and taller.

The stroller or child carrier may further be configured to provide an optional footrest to the child. For example, a platform, in one embodiment slidably held within the child harness assembly, may be provided. In an alternative embodiment, a footrest in the form of stirrups could be provided.

An insert may also be securable to the interior of the child compartment or to the side of the carrier frame structure 42 facing the child harness assembly 44. Such an insert is to reduce the internal space of the child compartment thereby to provide a snug, comfortable and supported fit with a child, This insert may be particularly useful when used with younger children, as it aims to prevent a younger child's chin from collapsing to their chest thereby reducing the risk of suffocation.

The backpack carrier described above may also have a corresponding docking station which could be used in the caregiver's home or the like, when the child need not be transported but it is preferred to have the child in an upright position. The docking station is to include a frame or base, structurally configured to ensure that it will not tip over when the backpack carrier or part thereof is secured to the docking station. It will be appreciated that the frame or base will have similar connecting means to engage with the connecting means provided on the backpack child carrier. For example, the frame or base may have a connector with a catch mechanism as described with reference to FIGS. 4a and 4b, when used with the backpack child carrier of 14 of FIGS. 1, 2 and 5. Alternatively, when used with the child carrier of FIGS. 6 to 8, the frame or base may need to include a panel section (akin to the collapsed seating arrangement of FIG. 6) together with biased clips.

Further features of the strollers and the backpack child carriers described above may include locking means integral to the stroller frame which locking means is to be used to secure the stroller to a stationary object (e.g. a railing or the like) when not in use This feature may be particularly useful as the backpack child carrier would under many circumstances be removed from the stroller (which is then abandoned) to enter areas where the stroller could not easily fit or manoeuvre. A tire pump may also be releasably connectable with the stroller frame.

In an embodiment where the child harness assembly and the carrier harness assembly are integrally formed as a backpack carrier, the carrier may include an enclosure, e.g. a layer of material with a closure such as a zip located (or secured) in proximity to the adult shoulder straps thereby to neatly tuck away the shoulder straps (and its associated adjustment straps) when the backpack carrier is not used as a backpack. Thus, although the adult shoulder straps stay attached to the carrier harness assembly, the straps are pressed against and secured closely to the frame underneath the enclosure material thereby ensuring that the straps are not caught on anything.

It is envisioned that the child carrier, and its component parts would be configured to be collapsible thereby to ensure easy storage. For example, the child carrier could be collapsible (i.e. fold flat or collapsible upon itself) as a single unit thereby to enable the storage thereof under the conventional seating arrangement of the stroller. In addition, the carrier harness assembly may be configured to be collapsible, similarly to store the carrier harness assembly, e.g., under the conventional seating arrangement or in an additional storage space, or even on the conventional seating arrangement, provided by the stroller. This will be particularly useful when the child harness assembly is connected to the stroller and the carrier harness assembly is removed therefrom.

Once stored within the stroller or in the stroller basket, a security cord may be mounted to the stroller, preferably to the stroller frame, which cord is used to secure the folded carrier to the bottom of the conventional carrier 18.

The child carrier may further include a removable sunshade and/or a rain cover. It will further be appreciated that the stroller itself may include a removable sunshade and/or weather cover.

A storage bag for valuables may also be releasably secured to either the parts of the carrier or stroller, thereby to allow a caregiver to easily remove the bag and therewith any valuables stored therein.

One or more strollers may also be connected together, for example to easily transport two children together. In one embodiment, the stroller frame may be altered and connectors in the form of brackets could be used to connect two single strollers side by side in order to create a double stroller, The front wheels may remain unchanged, but preferably the two inner rear wheels are disconnected thereby for the front wheels with only the outer rear wheels to support the double stroller.

It will further be appreciated that the combination child carrier and stroller may be adapted to provide a frame structure configured to support two adjacent conventional seating arrangements, further configured to releasably receive one or two child carriers as described above.

The present invention provides for a combination stroller and backpack child carrier that allows a child to be transported and/or carried, both in the stroller when the backpack child carrier or part thereof the child harness assembly) is connected to the stroller, and separately, in the backpack child carrier, in a suitable upright position which prevents plagiocephaly and limits infant/child reflux. When a child is carried in the backpack child carrier or the harness when secured to the stroller, the child has an unobstructed field of view, which additionally offers an alternative visual and kinesthetic experience to such children.

The feature of removing part of the backpack child carrier, i.e. the carrier harness assembly, allows for a caregiver to more easily interact with the child. Such arrangement also removes the bulk of material and potential extra weight of the carrier harness assembly off the body of the child, especially when the carrier is reclined into a horizontal position. The exposure of the body of the child when lying down in the child carrier is thus akin to a baby bassinette.

It will be understood that the invention disclosed and defined in this specification extends to all alternative combinations of two or more of the individual features mentioned or evident from the text or drawings. All of these different combinations constitute various alternative aspects of the invention.

1. A combination child carrier and stroller including:
a stroller having a frame to which is secured wheels; and
a child carrier having a saddle-like seating arrangement in which a child is to be seated vertically, the child carrier further including connecting means configured to be releasably secured to the stroller.

2. A combination child carrier and stroller as claimed in claim 1 wherein the child carrier includes a back support and a child safety harness, the child safety harness providing the saddle-like seating arrangement and the back support including the connecting means.

3. A combination child carrier and stroller as claimed in claim 2 wherein the child safety harness includes a hip strap and a crotch strap releasably connected to each other, wherein the child straddles the crotch strap while the hip strap stabilises the child's pelvic area while the child is in an upright vertical position.

4. A combination child carrier and stroller as claimed in claim 3 wherein the child safety harness includes shoulder straps, which together with the hip strap and crotch strap form a 5-point harness to ensure that the child's head and torso is held in an upright position.

5. A combination child carrier and stroller as claimed in claim 1 wherein the stroller includes connecting means to engage with the connecting means of the child carrier, the connecting means being configured to move the child carrier, when connected to the stroller, from a vertical, upright configuration to a horizontal, reclined configuration.

6. A combination child carrier and stroller as claimed in claim 5 wherein the connecting means of the stroller includes a hinge mechanism configured to pivot and lock the child carrier between the vertical, upright configuration and the horizontal, reclined configuration.

7. A combination child carrier and stroller as claimed in claim 6 wherein the hinge mechanism is configured to pivot and lock the child carrier in intermediate positions between the vertical, upright configuration and the horizontal, reclined configuration.

8. A combination child carrier and stroller as claimed in claim 2 wherein the stroller includes a conventional seating arrangement which is secured to the frame of the stroller.

9. A combination child carrier and stroller as claimed in claim 8 wherein the conventional seating arrangement is releasably secured to the frame of the stroller.

10. A combination child carrier and stroller as claimed in claim 8, wherein the stroller frame and/or stroller connecting means are configured to allow for both the conventional seating arrangement and the child carrier to be secured to the stroller at the same time.

11. A combination child carrier and stroller as claimed in claim 10 wherein the conventional seating arrangement is a pod seat adjacent to which the child carrier is secured.

12. A combination child carrier and stroller as claimed in claim 10 wherein the conventional seating arrangement includes a backrest and a seat portion, at least the seat portion being configured to be translated from a generally horizontal seating arrangement to a generally vertically collapsed arrangement, the frame and/or connecting means of the stroller further being configured to be connected to the child carrier when the seat portion of the conventional seating arrangement is in the vertically collapsed arrangement.

13. A combination child carrier and stroller as claimed in claim 2 wherein the child carrier includes a child harness assembly and a carrier harness assembly, the child harness assembly including the back support and the child safety harness, and the carrier harness assembly including a carrier frame structure and shoulder straps secured to the frame structure.

14. A combination child carrier and stroller as claimed in claim 13 wherein the child harness assembly and the carrier harness assembly are configured to be releasably secured to each other to form a backpack child carrier.

15. A combination child carrier and stroller as claimed in claim 14 wherein the child harness assembly and the carrier harness assembly each has complementary securing means at their respective lower ends and at their respective sides to releasably secure the assemblies together.

16. A combination child carrier and stroller as claimed in claim 13 wherein the child harness assembly and the carrier harness assembly are integrally formed or permanently secured to each other.

17. A child carrier including a saddle-like seating arrangement in which a child is to be vertically seated in use, the child carrier further including connecting means configured to releasably secure the child carrier to a stroller.

18. A child carrier as claimed in claim 17 further including:
a child harness assembly including a back support and a child safety harness secured to the back support and providing the saddle-like seating arrangement for a child when secured to the child safety harness; and
a carrier harness assembly including a carrier frame structure and shoulder straps secured to the harness assembly, the carrier harness assembly to be worn on the back of a caregiver.

19. A child carrier as claimed in claim 18 wherein the child harness assembly and carrier harness assembly are configured to be releasably secured to each other to form a backpack child carrier.

20. A child carrier as claimed in claim 19 wherein the child harness assembly and carrier harness assembly have complementary securing means at their respective lower ends and at their respective sides to releasably secure the assemblies together.

21. A child carrier as claimed in claim 18 wherein the child harness assembly and the carrier harness assembly are integrally formed or permanently secured to each other.

22. A child carrier as claimed in claim 18 wherein the child safety harness includes a hip strap and a crotch strap releasably connected to each other, wherein the child straddles the crotch strap while the hip strap stabilises the child's pelvic area while the child is in an upright vertical position.

23. A child carrier as claimed in claim 22 wherein the child safety harness additionally includes shoulder straps, which together with the hip strap and crotch strap form a 5-point harness to ensure that the child's head and torso is held in the upright vertical position.

24. A stroller including:
a frame having two opposing frame sections, each frame section including connecting means to engage connecting means of a child carrier; and
a conventional seating arrangement received and connected between the opposing frame sections, the conventional seating arrangement configured to be at least partially collapsible into a compact configuration in order for a child carrier having a saddle-like seating arrangement to be releasably secured to the stroller.

25. A stroller as claimed in claim 24 including a backrest and seat portion, at least the seat portion configured to be translated from a generally horizontal seating arrangement to a generally vertical collapsed arrangement, the stroller being configured to receive the child carrier when the seat portion is in the vertically collapsed arrangement.

26. A combination child carrier and stroller including a stroller as claimed in claim 24, further including a child carrier including a saddle-like seating arrangement in which a child is to be vertically seated in use, the child carrier further including connecting means configured to releasably secure the child carrier to the stroller.

27. A combination child carrier and stroller as claimed in claim 26 further including:
a child harness assembly including a back support and a child safety harness secured to the back support and providing the saddle-like seating arrangement for a child when secured to the child safety harness; and
a carrier harness assembly including a carrier frame structure and shoulder straps secured to the harness assembly, the carrier harness assembly to be worn on the back of a caregiver.
